(19) United States
(12) Patent Application Publication
(10) Pub. No.: US 2012/0326921 A1
(43) Pub. Date: Dec. 27, 2012

(54) Antenna Apparatus

(76) Inventor: David Geen, Dunfermline (GB)

(21) Appl. No.: 13/530,434

(22) Filed: Jun. 22, 2012

(30) Foreign Application Priority Data
Jun. 22, 2011 (GB) 1110521.0

(51) Int. Cl. H04B 7/185; H01Q 3/20

(52) U.S. Cl. 342/352; 343/761

(57) ABSTRACT

The invention relates to apparatus and a method for the provision of an antenna reflector which is provided in the form of a substantially circular parabolic dish provided to receive and/or transmit signals over known frequency ranges. The reflector can be moved between storage and in-use positions by the movement of segments of the reflector manually, but more typically by drive means connected thereto. The apparatus can also be provided with alignment means which allow the reflector to be positioned to receive signals from a known satellite when at a particular known location. The invention allows the use of a reflector to be achieved quickly and efficiently in potentially hazardous geographical locations.

### CROSS-REFERENCE TO RELATED APPLICATIONS

This United States patent application claims priority to British Patent Application No. 1110521.0 filed 22 Jun. 2011 which is incorporated herein by reference.

### BACKGROUND OF THE INVENTION

The invention to which this application relates is to a collapsible reflector or antenna, hereinafter referred to as a reflector, of a type which can be used to receive and/or transmit digital data, with the reflector being used at a particular location to be in communication with one or more satellites in space via which the digital data is transmitted to or from a remote location.

The provision of parabolic reflectors which may typically be parabolic or of another shaping to suit the specific requirements is well known and, most typically, the same are provided at a fixed location such as the roof or wall of a building, and, when positioned on the roof or wall of a building at the fixed position the same are aligned so as to provide the optimum communication “line of sight” with a particular satellite via which the data is transmitted. The reflector can then be connected to further apparatus which allows the data to be further processed into a format which can then be utilised such as, for the generation of video, images, audio and/or written data which can be viewed or listened to by a user of the apparatus.

Alternatively to the provision of the apparatus in a fixed location, it is known to provide reflectors as part of vehicles in which, most typically, the reflector is provided at a fixed location on the vehicle such as the roof or, yet further, to provide the apparatus in a collapsible format which allows the same to be carried in a smaller storage format than the extended in-use format and for use stored in a suitcase or in a “flyaway” format.

One such example of a collapsible parabolic reflector is disclosed in the U.S. Pat. No. 7,423,609 in which there are provided a number of sectors which can be rotated around a central hub between a position in which each of the sectors forms part of the parabolic reflector in position for use and a position in which the segments are located one over the other in sequence so as to provide the reflector in a storage position. The hub arrangement which is disclosed in that patent provides a number of sleeves which are each rotatable about a common axis and the rotation of the same is guided so as to move the sectors between the respective positions. Other known reflectors comprise a number of sectors which are moveable between storage and in use positions with movement from the central hub being in the manner of movement of the petals of a flower between extended and storage positions.

Conventionally, when a reflector is provided in a form to be movable between storage and used positions, it is typically for the purpose of allowing the same to be transported to different locations and, at each location, set up into an in-use position for use to transmit data. However, a problem which is experienced is that there can still be a prolonged time period between moving the reflector from a storage position to an in-use position and indeed in returning the reflector from the in-use position to a storage position. This time period can, at best, be frustrating to the operator of the apparatus and at worst, can be dangerous to the lives of the operator of the apparatus if, for example, the apparatus is being deployed in a hazardous environment such as in a military situation where a prolonged stay at a particular location can increase the likelihood of detection. Furthermore, it is often required that the deployment of the apparatus from a storage to an in-use position and back to the storage position is done rapidly so as to avoid detection of the operators of the apparatus as a result of, either, the geographical location of the operators being detected due to their presence at that location while the deployment is occurring and/or due to the detection of the digital data transmission and/or receiving.

It will therefore be appreciated, that the faster the time for deployment of the apparatus between the storage and the in-use position and from the in-use position to a storage position the better. At the same time, it is required that the apparatus is required to be relatively lightweight in order to allow the same to be transportable.

### BRIEF SUMMARY OF THE INVENTION

The aim of the present invention is therefore to provide a reflector apparatus which is deployable between storage and in-use positions in an efficient and timely manner.

In a first aspect of the invention, there is provided apparatus including a reflector for the receipt and/or transmission of data, said reflector formed from a plurality of segments, said sectors movable between in-use and storage positions around a substantially centrally positioned axis of the reflector in a fan like manner where the segments lie side by side in the in use position and are positioned to at least partially overlap in a storage position and wherein the apparatus further includes a drive means to cause the driven movement of the segments from at least one of movement from the storage to the in-use position and/or the in-use to the storage position.

In one embodiment, the drive means are provided as a drive module which can be selectively attached to the apparatus thereby allowing the segments to be moved between in-use and storage positions either by manual movement, when the drive means is not attached or may be out of power, or by powered means when the drive means is attached to the apparatus and has power.

Preferably, the drive means module will be used to move the segments between both of the storage to in-use position and the in-use to storage positions.

In one embodiment, the movement of the segments is achieved by movement of at least one sleeve which is located at the said axis.

In one embodiment, the drive is applied to the sleeve which is attached to the segment which has the furthest rotational movement to move the same between the storage and in-use positions. Typically, as the movement is applied to said segment sleeve, the sleeve and/or segment mechanically connects with at least one of the other segments from it's position at that time and that segment mechanically connects with the next segment to move the same and so on until all of the segments are moved to the new required position in sequence.

Typically, the movement of the segments to the in-use position and the movement of the segments back to the storage position, is performed in a sequential manner such that the last segment to move from the storage to the in-use position and to move from the in-use position to the storage position is that which is closest to the storage position and therefore has the least required travel.

Typically, the movement of each of the segments with regard to at least the adjacent segment, is guided by guide means provided on a sleeve located with that particular segment and which guide means interact with matching guide means provided on at least one of the sleeves adjacent thereto.

In one embodiment the drive means can be provided with power from a generator or alternatively from a power cell such as one or more batteries.

Typically, the movement of the segments between in-use and storage positions is similar to that of the sectors of a fan with the exception that the sectors are moved such that in the in-use position a full reflector is formed. Typically, when the segments are at or close to the fully extended position, the same are moved substantially parallel to the said axis about which the same have been rotated so as to move the respective segments to lie in the same plane and thereby provide a substantially uniform and smooth data receiving face of the reflector.

In one embodiment the reflector in the in-use position can be circular, elliptical and/or non-circular in shape.

In one embodiment, the movement of the sectors between the storage and in-use positions, is commenced by the operator of the apparatus pressing a switch which is connected to the drive means to drive at least one of the segments to cause movement of the same, with the movement of each of the particular segments, being guided by the inter-engaging guide means.

Typically, when the movement of the segments to either of the storage or in-use positions has been achieved, brake means are provided or a stop mechanism is provided so as to cause the drive means movement force to be stopped.

In one embodiment, the apparatus also includes means for alignment of the reflector such that when the same is in the in-use position the reflector is aligned to receive and/or transmit data from a particular satellite.

In on embodiment the alignment means are provided as part of the drive means and exert a movement force on the mounting assembly on which the reflector is mounted.

In one embodiment, the apparatus is provided at a first location and is operable by an operator of the apparatus who is at a second location. In one embodiment, the apparatus can be located on, for example the roof of a vehicle or building and the deployment and operation of the reflector apparatus can be performed by, for example, a person sitting within the vehicle or building via remote control apparatus such as a wireless communication system.

In one embodiment the apparatus is provided to be carried in the form of a flyaway terminal or may be provide within a rucksack to be carried on the person.

In accordance with a further aspect of the invention there is provided a method for deploying a reflector formed from a series of segments, said method including the steps of connecting a drive means to the reflector when the reflector is in a storage position in which a plurality of said segments are overlapping, commencing movement of the segments via a movement force applied from the drive means so as to rotate a plurality of the segments about an axis located substantially centrally of the reflector so as to extend said segments around the axis in a fan like manner until the edges of adjacent segments abut in substantially the same plane, providing guide means between the respective segments such that the relative movement between the segments is guided to bring the segments into a position in which the reflector is formed for use, operating data transmission and/or receiving apparatus to transmit and/or receive data via said reflector, and at the cessation of the transmission or receipt of said data, applying a movement force from the drive means to the segments to return the segments to a storage position.

In one embodiment, the method comprises the additional steps of operating alignment means to operate the mounting apparatus on which the parabolic reflect is located so as to allow relatively rotational and/or angular adjustment of the reflector with respect to the mounting means in order to align the same to receive and/or transmit data from a particular satellite at a known location. Typically the alignment takes into account the particular geographical location of the apparatus at the point of use and the operator is aware of the location of one or more satellites with which the apparatus may be use to transmit and/or receive data.

Typically, the alignment of the reflector is performed once the reflector has been moved to an in-use position or alternatively, where time is of the essence the alignment may be performed whilst the reflector is being deployed to the in-use position.

### BRIEF DESCRIPTION OF THE DRAWINGS

Specific embodiments of the invention are now described with reference to the accompanying drawings wherein;

FIG. 1 illustrates apparatus in accordance with one embodiment of the invention with the reflector in a storage position;

FIG. 2 illustrates the apparatus of FIG. 1 intermediate the storage and in-use positions;

FIG. 3 illustrates the apparatus of FIG. 3 with the reflector in the in-use position; and

FIG. 4 illustrates the alignment of the apparatus of FIGS. 1-3.

### DETAILED DESCRIPTION OF THE PREFERRED EMBODIMENT(S)

Referring now to the Figures there is illustrated apparatus 2 including a reflector formed from a plurality of segments 4 which are movable about a central hub 6. The reflector is located on a mounting assembly 8 which can be formed to suit the particular use and location at which the reflector is to be deployed. For example a first form of mounting assembly can be provided for the location of the reflector on a vehicle or building whilst a second form of mounting assembly can be provided for location of the reflector on the ground where the same is provided to be manually transportable.

The apparatus also includes a drive unit or module 10. The module may be provided entirely located on the mounting assembly or as shown may include a first part 10a including a motor which is connected to the mounting assembly and the reflector segments and a second part 10b which is connectable to the first part but provided separate therefrom as shown. The second part can also include control means 11 which allow the selective operation of the drive means and hence control of deployment and alignment of the reflector. Alternatively the drive unit or module can be a known powered item or tool which can be connected to and/or adapted to drive the movement of the reflector between the storage and in-use positions. One such tool could be a tool with a rotary drive such as a powered drill and which can be connected, possibly to the central shaft of the reflector and operated to rotate and move the segments in the desired manner.

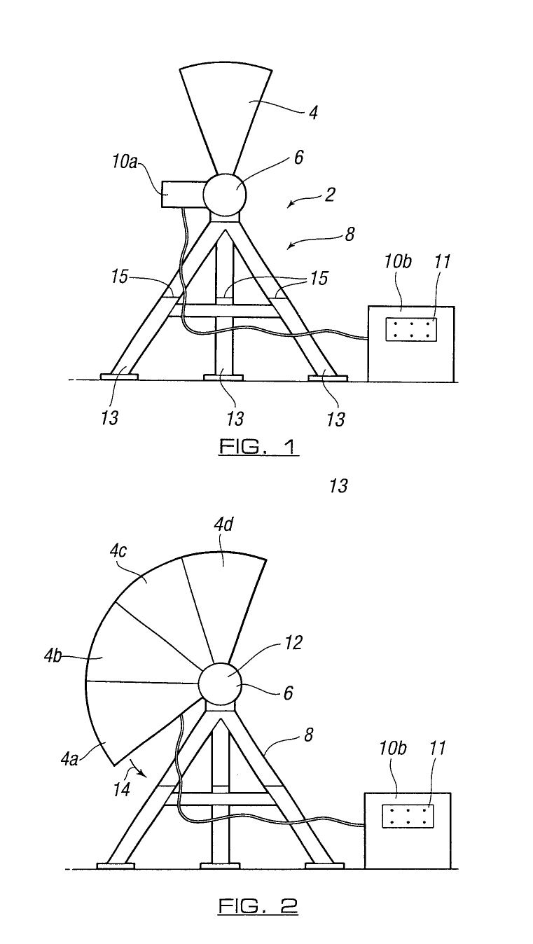

As shown in FIG. 1 the apparatus can be provided in a storage position in which the segments 4 overlie each other. The mounting assembly 8 may also be collapsible via movement of the legs 13 about respective pivot axes 15 to further reduce the storage size of the apparatus.

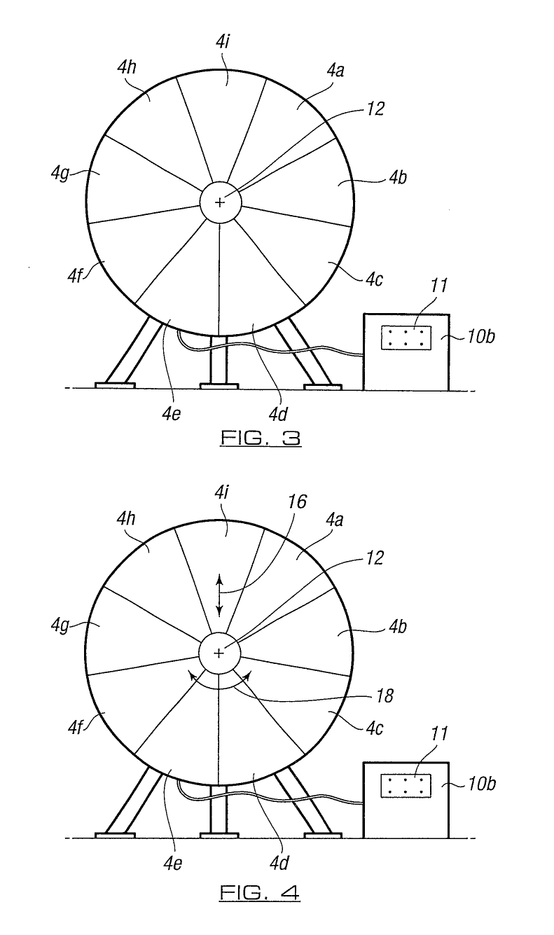

When deploying the apparatus to an in-use position it is necessary to extend the mounting assembly 8 to the position shown and connect the drive module 10 to provide drive via the motor 10a to at least one of the segments, which typically will be the segment which is required to be moved furthest to be deployed. FIG. 2 illustrates the reflector in a partially deployed position in which the leading segment 4a is driven to be rotated around the central axis 12 of the hub 6 in the direction of arrow 14. As the segment 4a moves so it contacts with the adjacent segment 4b to provide drive movement thereto and so on in sequence with the segments 4a-i until the segment 4a and the subsequent segments reach their final positions as shown in FIG. 3 in which the reflector is formed in the in use position.

Typically once the segments have reached the position shown in FIG. 3 the final movement component will be a linear movement along the axis 12 to bring the segments to lie in the same plane. Each of these movement components is typically driven by the motor of the drive means thereby ensuring that the deployment is efficient and quick.

To move the reflector from the in-use to storage position the motor can be reversed in direction of drive so as to draw the segments back into the position shown in FIG. 1 with once again the movement of the segments being similar to that of a fan.

FIG. 4 illustrates the manner in which the drive module can also be used, typically via a separate motor to allow the elevation and azimuth position of the reflector to be adjusted as illustrated by arrows 16, 18, with respect to the mounting assembly so as to allow the reflector to be optimally positioned to receive and/or transit data via a satellite at a known location.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification, but is limited only by the scope of the attached claims, including the full range of equivalency to which each element thereof is entitled.

1. Apparatus, said apparatus comprising:
a reflector for receipt and/or transmission of data, said reflector formed from a plurality of segments movable between in-use and storage positions around a substantially centrally positioned axis of the reflector in a fanlike manner where the segments lie side-by-side in the in-use position and are positioned to at least partially overlap in a storage position; and
wherein the apparatus further includes a drive means to cause the driven movement of the plurality of segments from at least one of movement from the storage to the in-use position and the in-use to the storage position.

2. Apparatus according to claim 1 wherein the drive means are provided as a drive module being selectively attached to the apparatus.

3. Apparatus according to claim 1 wherein the plurality of segments can be moved between in-use and storage positions by manual movement when the drive means is not attached or is out of power.

4. Apparatus according to claim 2 wherein the drive means is used to move the plurality of segments between both of the storage to in-use and the in-use to storage positions.

5. Apparatus according to claim 1 wherein movement of the plurality of segments is achieved by movement of at least one sleeve which is located at said axis of the reflector.

6. Apparatus according to claim 5 wherein the drive means is applied to the sleeve which is attached to the segment which requires the furthest rotational movement to move the same between the storage and in-use positions.

7. Apparatus according to claim 6 wherein as movement is applied to a segment sleeve, the sleeve and/or segment mechanically connects with at least one of the other segments to move the same and that segment mechanically connects with the next segment to move the same and so on until all of plurality of segments are moved to a new required position in sequence.

8. Apparatus according to claim 1 wherein movement of the plurality of segments is performed in a sequential manner.

9. Apparatus according to claim 8 wherein the last segment to move from either the in-use or the storage position is that which has the least required travel.

10. Apparatus according to claim 5 wherein movement of each of the plurality of segments with regard to at least an adjacent segment, is guided by guide means provided on a sleeve located with that particular segment and which guide means interact with matching guide means provided on a sleeve of said adjacent segment.

11. Apparatus according to claim 1 wherein the drive means are provided with power from at least one of a generator one or more power cells.

12. Apparatus according to claim 1 wherein when the plurality of segments are moved to the in-use position a full, circular reflector is formed.

13. Apparatus according to claim 12 wherein when in the in-use position the plurality of segments lie in substantially the same plane to provide a substantially uniform and smooth data receiving face of the reflector.

14. Apparatus according to claim 1 wherein the apparatus includes aligning means for alignment of the reflector when in the in-use position to align the same to receive and/or transmit data from a particular satellite.

15. Apparatus according to claim 1 wherein control means are provided for movement of the reflector between the storage and in-use positions when the reflector is provided at a first location and is operable from a second location via the control means.

16. A method for deploying a reflector formed from a series of segments, said method including the steps of:
connecting a drive means to the reflector when the reflector is in a storage position in which a plurality of said segments are overlapping;
commencing movement of the segments via a movement force applied from the drive means to rotate a plurality of the segments about an axis located substantially centrally of the reflector to extend said segments around the axis in a fan-like manner until edges of adjacent segments abut in substantially the same plane;
providing guide means between the respective segments such that the relative movement between the segments is guided to bring the segments into a position in which the reflector is formed for use;
operating data transmission and/or receiving apparatus to transmit and/or receive data via said reflector; and
at the cessation of the transmission or receipt of said data, applying a movement force from the drive means to the segments to return the segments to a storage position.

17. A method according to claim 16 wherein the method comprises the additional steps of operating alignment means to operate mounting apparatus on which the reflector is located to allow rotational and/or angular adjustment of the reflector with respect to the mounting means to align the same to receive and/or transmit data from a particular satellite at a known location.
